(19) United States
(12) Patent Application Publication
(10) Pub. No.: US 2004/0091549 A1
(43) Pub. Date: May 13, 2004

(54) Reduction of arsenic and lead leaching in pressure treated wood and painted surfaces

(76) Inventor: Keith E. Forrester, Meredith, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/684,052

(22) Filed: Oct. 10, 2003

Related U.S. Application Data
(60) Provisional application No. 60/417,683, filed on Oct. 10, 2002.

(51) Int. Cl. A01N 59/22

(52) U.S. Cl. 424/622

(57) ABSTRACT

Objects painted with heavy metal based paint, particularly lead based paint, and chromated copper arsenate-treated wood represent point sources of heavy metals. Humans can be exposed to the heavy metals either through direct contact with a surface containing heavy metal or by contacting heavy metals that leached from a surface, potentially leading to toxic or carcinogenic effects. The present invention provides methods of reducing the solubility of heavy metals, so as to reduce their leaching and bioavailability. The methods typically involve applying a stabilizing agent comprising phosphate, silicate, chloride, sulfate, a base (e.g., lime), a source of iron ions (e.g., ferric chloride, ferric sulfate) or a combination thereof to a surface.

### RELATED APPLICATION

This application claims the benefit of U.S. Provisional Application No. 60/417,683, filed on Oct. 10, 2002. The entire teachings of the above application are incorporated herein by reference.

### BACKGROUND OF THE INVENTION

Chromated copper arsenate (CCA) is a pesticide commonly used in pressure-treated wood. CCA protects wood from deterioration, and CCA-treated wood is often found in outdoor wooden structures such as decks and children's play equipment. According to the Connecticut Department of Public Health, recent studies have shown that rainwater leaches CCA from pressure-treated wood that is not sealed, leading to potential contamination of the soil underneath the wood. Also, a significant residue of CCA can be left on the surface of pressure-treated wood. This residue can easily be removed from the wood surface and transferred onto objects contacting the wood surface, such as skin, hair and clothing.

The most toxic part of the CCA pesticide is the heavy metal arsenic. Arsenic is a known carcinogen, which can also be toxic to the skin and internal organs with long term exposure. There are concerns that regular contact with arsenic leached from pressure-treated wood can lead to an increased risk for cancer or other long-term health effects. It has been shown that exposure to CCA-treated wood can be the major source of arsenic for children who frequently play on structures made of CCA-treated wood.

Lead-containing paints also represent a significant public health concern. Soil adjacent to houses painted with exterior lead based paint can contain lead levels as high as 10,000 ppm. Once soil has become contaminated with lead, it remains a long term source of lead exposure. Similarly, interior lead based paint contributes to increased lead levels inside a home. Lead can be mobilized from a painted surface by a number of mechanisms including natural weathering processes, such as exposure to rain or other water and abrasion of the surface.

Lead that is ingested or absorbed by an organism is recognized as a neurotoxin, and children are particularly susceptible to its effects. As such, lead poisoning is one of the most common pediatric health problems in the United States. The Center for Disease Control defines childhood lead poisoning as occurring when blood lead levels are greater than 10 micrograms per deciliter based on evidence showing decreased intelligence and slower neurological development in children.

Thus, a method is needed to reduce or prevent the mobilization of heavy metals into the environment from sources such as CCA-treated wood and surfaces painted with lead based paint. Alternatively, a method is needed to reduce the bioavailability of heavy metals if they are liberated into the environment.

### SUMMARY OF THE INVENTION

It has now been found that several sources of phosphate, chloride, sulfate, iron ions, bases (e.g., lime and magnesium oxide) and/or silicate can be used to reduce the surface solubility of lead and arsenic, when the surfaces are not substantially damaged or destroyed (e.g., through demolition or other waste-generating processes). When intact wood, steel or concrete surfaces painted with a lead-based paint were treated with a solution containing phosphate, iron and chloride bearing phosphate, or silicate, the amount of lead leaching from the surface into distilled water over 24 hours was reduced to an undetectable level (Example 1). Similarly, when CCA-treated wood was treated with a solution containing iron chloride or iron sulfate and subjected to the same leaching procedure, arsenic was reduced to non-detectable in the leachate (Example 1). Solutions containing iron(III) chloride or iron(III) sulfate with wet process amber phosphoric acid also reduced the amount of arsenic detected in the leachate of CCA-treated wood, while a slurry of iron(III) chloride and calcium oxide (lime) resulted in an undetectable amount of arsenic in the leachate (Example 1).

The present invention includes a method of reducing solubility of a heavy metal in wood containing a heavy metal, particularly pressure treated wood, to reduce leaching of the heavy metal from the wood when the wood is exposed to natural or induced leaching conditions, comprising applying a stabilizing agent comprising phosphate, silicate, chloride, sulfate, a base (e.g., lime), a source of iron ions or a combination thereof onto the wood to produce a treated wood, where the stabilizing agent binds to the heavy metal to form a heavy metal complex when exposed to natural or induced leaching conditions. Preferably, the wood contains arsenic (e.g., from treatment with chromated copper arsenate). Wood treated by this method is left intact, such that it is not demolished or otherwise generated into a waste for more than one month, more than six months, more than one year, more than two years, more than five years or more than ten years after treatment with the stabilizing agent.

In another embodiment, the present invention is a method of reducing solubility of a heavy metal in wood containing a heavy metal to reduce bioavailability of the heavy metal from the wood when the wood is contacted directly by an organism or a substance that directly or indirectly contacts an organism, comprising applying a stabilizing agent that contains phosphate, silicate, chloride, sulfate, a base, a source of iron ions or a combination thereof onto the wood to produce a treated wood, where the stabilizing agent binds to the heavy metal to form a heavy metal complex. Wood treated by this method is left intact, such that it is not demolished or otherwise generated into a waste for more than one month, more than six months, more than one year, more than two years, more than five years or more than ten years after treatment with the stabilizing agent.

The present invention also includes a wooden object containing a heavy metal, where the wooden object is coated with a stabilizing agent comprising phosphate, silicate, chloride, sulfate, a base, a source of iron ions or a combination thereof to produce a treated wooden object, where the stabilizing agent binds to the heavy metal to form a heavy metal complex when exposed to natural or induced leaching conditions, which reduces leaching of the heavy metal from the wooden object when the wooden object is exposed to natural or induced leaching conditions. Wooden objects treated by this method are left intact, such that they are not demolished or otherwise generated into a waste for more than one month, more than six months, more than one year, more than two years, more than five years or more than ten years after treatment with the stabilizing agent.

The present invention includes a method of reducing solubility of a heavy metal on a surface having painted thereon a heavy metal containing paint to reduce leaching or bioavailability of the heavy metal from said surface when the surface is exposed to natural or induced leaching conditions, consisting essentially of applying a stabilizing agent comprising phosphate, silicate, chloride, sulfate, a base, a source of iron ions or a combination thereof onto the surface having painted thereon the heavy metal containing paint to produce a treated paint, where the stabilizing agent binds to the heavy metal to form a heavy metal complex when exposed to natural or induced leaching conditions and where the treated paint is not removed from the surface. Typically, the heavy metal containing paint contains lead. A surface treated by this method is left intact, such that it is not demolished or otherwise generated into a waste (e.g., by sandblasting or high-pressure water treatment) for more than one month, more than six months, more than one year, more than two years, more than five years or more than ten years after treatment with the stabilizing agent.

In yet another embodiment, the present invention is a surface having painted thereon a heavy metal containing paint having applied thereto a stabilizing agent comprising phosphate, silicate, chloride, sulfate, a base, a source of iron ions or a combination thereof to produce a treated paint, where the stabilizing agent binds to the heavy metal to form a heavy metal complex when exposed to natural or induced leaching conditions to reduce leaching of the heavy metal from the surface when the surface is exposed to natural or induced leaching conditions. A surface treated by this method is left intact, such that it is not demolished or otherwise generated into a waste (e.g., by sandblasting or high-pressure water treatment) for more than one month, more than six months, more than one year, more than two years, more than five years or more than ten years after treatment with the stabilizing agent.

The present invention has the advantage of reducing surface solubility of various heavy metals, so as to reduce or prevent the leaching of the heavy metals from the surface of an object or reduce bioavailability of the heavy metals. This reduces the risk of soil contamination and toxicity to humans and other organisms. The sources of phosphate, silicate, chloride, sulfate, bases, and/or iron ions are readily available at a low cost, often making use of waste materials from other processes. Thus, the methods of the present invention represent an environmentally benign means of limiting heavy metal contamination.

### DETAILED DESCRIPTION OF THE INVENTION

The present invention provides methods of reducing the solubility of heavy metals in heavy metal containing paint or wood, so as to reduce the leaching and bioavailability of heavy metals from such materials. Wood or wooden objects treated by methods of the present invention typically contain chromated copper arsenate or are painted with a heavy metal containing paint. Typically, wood treated by a method disclosed herein is unpainted, uncoated, and unsealed, such that the wood is bare. Other objects or surfaces painted with a heavy metal containing paint are also treatable by methods disclosed herein. Suitable objects or surfaces include those made of steel, iron, concrete, cement, plastic or other synthetic polymer, rubber or a natural polymer, paperboard, cardboard, fiberboard, fabric, asphalt, brick, stone and combinations thereof.

The term “leaching or leachable conditions,” as used herein, means any natural or induced condition that causes a heavy metal to solubilize and be removed from a heavy metal containing material. Natural or induced leaching conditions typically involve treating a material with water or rainwater that has a pH of 7 or less, typically 6 or less. The heavy metal containing material is treated with a stabilizing agent comprising phosphate, silicate, chloride, sulfate, a base, a source of iron ions or a combination thereof to form a heavy metal complex such as an insoluble heavy metal mineral. Preferably, the heavy metal complex is insoluble (e.g., the Kₛₚ is less than 10⁻³⁰, 10⁻⁴⁰, 10⁻⁵⁰, 10⁻⁶⁰, 10⁻⁷⁰, or 10⁻⁸⁰). Formation of a heavy metal complex upon the surface of the heavy metal containing material will stabilize the heavy metal such that its leachability, under natural or induced leaching conditions, is reduced compared to its untreated form. A reduction in leaching can be assessed by any natural or induced leach test conditions such as, but not limited to, Toxicity Characteristic Leaching Procedure (TCLP, Method 1311), Simulated Precipitant Leaching Procedure (SPLP, Method 1310, which simulates rainwater leaching), Japan DI (uses acid adjusted deionized (DI) water for 6 hours to simulate rainwater leaching), Swiss sequential DI (uses sequential DI water leaching to simulate rainwater), rainwater, carbonated water, buffered citric acid (e.g., the California citric acid leaching test), acetic acid, distilled water, in vitro HCl-based bioavailability leach tests, the method involving deionized water described in Example 1, and other related methods.

The TCLP test is set forth in the Federal Register, vol. 55, no. 126, pp. 26985-26998 (Jun. 29, 1990) and described in the U.S. E.P.A. SW-846 manual. Briefly, in a TCLP test, 100 grams of material are tumbled with 2000 mL of diluted and buffered acetic acid for 18 hours. The extract TCLP solution is made up from 5.7 mL of glacial acetic acid and 64.3 mL of 1.0 N sodium hydroxide up to 1000 mL dilution with reagent water. SPLC uses the same tumbling procedure as the TCLP test, but replaces acetic acid with simulated acid rain (e.g., a solution of carbonic acid to pH 5.8 east of the Mississippi river and pH 5.9 west of the Mississippi river).

Suitable citric acid leach tests include the California Waste Extraction Test (WET), which is described in Title 22, Section 66700, “Environmental Health” of the California Health & Safety Code. Briefly, in a WET test, 50 grams of material are tumbled in a 1000 mL tumbler with 500 grams of sodium citrate solution for a period of 48 hours. The concentration of leached heavy metal is then analyzed by Inductively-Coupled Plasma (ICP) after filtration of a 100 ml aliquot from the tumbler through a 0.45 micron glass bead filter. A WET test result of greater than 5 ppm lead or 5 ppm arsenic will result in the soil being classified as hazardous in California.

The invention further pertains to methods of reducing the bioavailablity of heavy metals upon exposure to the stomach acids of animals or humans or other biological exposures. Bioavailability is the degree to which or rate at which a substance is absorbed or becomes available at the site of physiological activity after administration. Bioavailability can be assessed, in animals, for example, by studying metal uptake in the gastrointestinal tract and other organs.

A “stabilizing agent,” as used herein, causes one or more heavy metals to precipitate upon contact. The amount of stabilizing agent incorporated within and/or upon a material surface is determined based on the character of the material to be treated, the heavy metals present, desired heavy metal solubility reduction potential, desired heavy metal containing mineral toxicity, and desired heavy metal containing mineral formation relating to toxicological and site environmental control objectives. Heavy metals include, but are not limited to, copper, arsenic, chromium, lead, nickel, manganese, cobalt, zinc, cadmium, and mercury. Preferably, the heavy metal is arsenic or lead. Heavy metals are typically stabilized in a cationic form, but can optionally be stabilized as an elemental form or an anion (e.g., an oxyanion). More than one heavy metal can be treated simultaneously with a stabilizing agent. Stabilizing agents of the present invention comprise phosphate, silicate, chloride, sulfate, a base, a source of iron ions or a combination thereof and can contain one or more of the individual substances listed below.

Preferred stabilizing agents that contain phosphate include technical grade phosphoric acid, green phosphoric acid, wet process amber phosphoric acid, phosphoric and sulfuric acid blend coproduct or sodium chloride or calcium chloride amended phosphoric acid (phosphoric acid containing sodium chloride or calcium chloride). The term “wet process amber phosphoric acid” refers to phosphoric acid formed by acidolation of phosphate rock ore with sulfuric acid. The term “green phosphoric acid” refers to phosphoric acid formed by calcined ore acidolated with sulfuric acid. The term “phosphoric and sulfuric acid coproduct” refers to a by-product from the finishing of aluminum comprising phosphoric acid and sulfuric acid and optionally comprising aluminum and other metals (such as iron). In certain cases such as use of wet process amber and green phosphoric acid, such acids comprise sulfuric acid, vanadium, iron, aluminum and other complexing agents. Preferably, a stabilizing agent comprises phosphate and calcium. Another preferred stabilizing agent comprises phosphate and chloride, such as sodium chloride or calcium chloride amended phosphoric acid (e.g., where the sodium chloride or calcium chloride content is about 10% by weight).

Stabilizing agents comprising silicate include aqueous solutions of sodium silicate (e.g., where the sodium silicate content is about 10% by weight). Stabilizing agents comprising silicate preferably also contain phosphate.

Stabilizing agents, particularly arsenic stabilizing agents, contain iron ions, typically iron(II) and/or iron(III) ions. Preferred sources of iron ions include iron(III) chloride and iron(III) sulfate. Iron ions can be supplied by a surface or object being treated, particularly a surface or object that contains iron arsenate complexes, so that the stabilizing agent is contacted to the surface in the presence of a source of iron ions. For purposes of this invention, treating a surface with a stabilizing agent comprising one or more substances in the presence of a source of iron ions is considered to be equivalent to treating a surface with a stabilizing agent comprising both the one or more substances and a source of iron ions.

Stabilizing agents comprising a base typically comprise one or more basic salts, such as a alkaline or alkaline earth metal oxide, carbonate or bicarbonate. A preferred base is lime. Stabilizing agents comprising lime include aqueous solutions or slurries of calcium oxide, magnesium oxides and combinations thereof.

In one embodiment, a stabilizing agent comprises phosphate, silicate, iron ions or a combination thereof.

If a material contains arsenic, interaction of the stabilizing agent with arsenic typically forms a ferric-arsenate-base complex, a phosphate-calcium-arsenic complex (e.g., arsenic-substituted calcium phosphate crystals) or a phosphate-iron-arsenic complex. In such circumstances, the stabilizing agent contains phosphate and optionally iron ions. Calcium and iron can be present in the material being treated, in the stabilizing agent, or in a separate composition. The calcium and/or iron ions are typically applied as part of the stabilizing agent, but can also be applied simultaneously with the stabilizing agent or sequentially with the stabilizing agent. Under circumstances where both a source of iron ions and phosphate are applied, the source of iron ions is preferably applied before phosphate. Typical stabilizing agents for arsenic include a source of iron ions, often in the presence of a base, although the base is not required.

Preferably, if a material contains lead, interaction of the stabilizing agent with lead produces the mineral apatite lead phosphate (Ca₄(Pb)(PO₄)₃OH), lead phosphate (Pb₃(PO₄)₂), lead silicate (PbSiO₃), lead sulfide (PbS), chloropyromorphite (Pb₅(PO₄)₃C1), plumbogummite, minerals containing iron (e.g., corkite), and combinations thereof. Typical stabilizing agents for lead include phosphate, often in combination with chloride and/or sulfate, although the latter anions are not required. Other typical stabilizing agents for lead include silicate, optionally in combination with one or more of the components listed above.

Stabilizing agents can be applied by a variety of methods, so long as a sufficient quantity of stabilizing agent adheres to a material or object being treated to reduce solubility of one or more heavy metals to a desired level. Preferably, a stabilizing agent is applied by a wet spray method. In a wet spray method, the stabilizing agent is applied to a material or object as a solution, liquid, or other sprayable formulation. Suitable solutions include dilute latex washes, which is a latex paint typically diluted with water or other suitable solvent. Latex paint comprising a stabilizing agent is further disclosed in U.S. Ser. No. 09/649,186, now U.S. Pat. No. 6,515,053, the entire teachings of which are incorporated herein by reference. Oil-based paint can also comprise a stabilizing agent. A stabilizing agent can be mixed with a stain or dye, such as a blended dye, so as to enable one to readily discern where the stabilizing agent has been applied or to give a surface or an object a visually pleasing appearance. Dyes and components of a solution, liquid or other sprayable formulation other than the stabilizing agent typically do not substantially contribute to the activity of a stabilizing agent and should not substantially interfere with the action of a stabilizing agent.

Stabilizing agents, optionally mixed with one or more other components, can also be applied to a material or object as a dry chemical or a dry slurry. The use of a dry chemical or slurry is indicated, for example, when treating a material that is saturated with water, such that application of a solution would not effectively penetrate the material. A dry chemical or dry slurry can contain a dye or stain. Dry chemicals and slurries can also contain an agent to assist in adhering the chemical or slurry to the surface being treated. Components of a dry chemical or dry slurry other than the stabilizing agent do not substantially contribute to the activity of a stabilizing agent and should not substantially interfere with the action of a stabilizing agent.

In another embodiment, a wiping device (e.g., made of paper, cloth, other woven natural or synthetic materials) is impregnated with a stabilizing agent, which can be present as a solution, dry chemical or dry slurry. Preferably, the wiping device is impregnated with a solution comprising a stabilizing agent. Such wiping devices are effective to reduce the solubility of heavy metals on surfaces, objects and materials disclosed herein. Also, such wiping devices can be used on organisms, particularly the skin of humans, after contact with a heavy metal or if contact with a heavy metal is suspected. This allows, for example, one to reduce the likelihood of exposure to a heavy metal by a hand-to-mouth route. Compounds other than a stabilizing agent can be present, so as to modify the pH of the stabilizing agent or assist in adhering the stabilizing agent to the wiping device. A wiping device intended for use on skin can also contain agents found in cosmetics such as moisturizers, cleansers, detergents, antimicrobials, antibiotics, scent, coloring agents and the like.

It does not appear that the concentration of stabilizing agent applied to a material is crucial to the invention, so long as the total amount of stabilizing agent applied is sufficient to reduce heavy metal solubility on the surface of a material to a desired level. For example, concentrations of P₂O₅ ranging from 10% to 50% by weight have been found to be suitable in stabilizing agents. A surface typically only retains 1% to 5% by thin (1/18 inch) board weight of a composition containing a stabilizing agent. The remaining composition drips off of a surface unless the stabilizing agent is mixed with an adherent such as latex.

The amount of stabilizing agent required in the present method is minimal, especially in comparison with the amount of stabilizing agent required to treat a surface or an object that is becoming waste material (e.g., CCA-treated wood destined for a landfill, demolished structures, paint removed from a surface). Typically, a thin coating of a stabilizing agent is sufficient to reduce leaching of a heavy metal from an object or a surface that is substantially intact. Such thin coatings typically have a thickness of less than about 100 microns, less than about 50 microns, less than about 10 microns, less than about 5 microns, less than about 2 microns, less than about 1 micron, less than about 750 nm, less than about 500 nm, less than about 250 nm, less than about 100 nm or less than about 50 nm. While not being bound by theory, the thin coatings are expected to form a barrier over a surface and rapidly form insoluble crystals with heavy metals present in the surface, thereby reducing leaching.

Stabilizing agents can be applied to a material one or more times. Repeated or regular applications of a stabilizing agent can be made. Such repeated applications are particularly advantageous when a material contains a large amount of heavy metal, when a material is repeatedly exposed to leaching conditions, when additional heavy metal is brought to the surface of a material, when the material has a high moisture or solvent content, or when the surface of the material is weathered or abraded.

When an object or material painted with heavy metal based paint (e.g., lead based paint) is treated by a method disclosed herein, the paint is preferably not removed after treatment with a stabilizing agent. Most prior art relates to methods of stabilizing heavy metal based paint that is to be removed. The present method is particularly advantageous for minimization of heavy metal leaching from an object, when the object is to be exposed to leaching conditions over a period of time (e.g., an object that is exposed to weather). Also, methods disclosed herein are useful in treating painted objects where the cost of paint removal is too high, such as at large building structures or structures where the base paint retains a good adhesion character. In addition, the method of the present invention can be used to repair a breach or other fissure in a painted surface, so as to reduce leaching of heavy metals from or through the breach.

The examples below are merely illustrative of this invention and are not intended to limit the invention in any way.

Exemplification

### EXAMPLE 1

A water leach test was conducted by submerging objects in a deionized water bath for 24 hours. The weight ratio of water to object was about 10 to 1. Objects subjected to the test included wood, steel and concrete objects painted with lead-based paint and CCA-treated wood. The painted objects were recovered from the South Boston convention center warehouse. Prior to the test, without curing, objects were treated by spraying one coat of stabilizer solution with 1% by weight solutions of technical grade phosphoric acid (HP), green phosphoric acid (WAG), wet process amber phosphoric acid (WAA), phosphoric and sulfuric acid blend coproduct (CP), 10% by weight sodium chloride amended phosphoric acid (WACL), 10% by weight aqueous sodium silicate (NS), ferric chloride (FC), ferric sulfate (FS), 1:1 mixtures of FC or FS and HP, or a 1% ferric chloride and 0.5% lime hydrate 1:1 water solution.

Following submersion in deionized water for 24 hours, the water was tested for the presence of lead (the objects with lead-based paint) or arsenic (the CCA-treated wood). Ten milliliter aliquot samples were submitted to Eastern Analytical Labs and measured by EPA method 200.7. The results are reported below in mg metal per L water.

| | | 1% | 1% | 1% | 1% | 1% | 1% |
|---|---|---|---|---|---|---|---|
| Object | Control | HP | WAG | WAA | NS | CP | WACL |
| Painted | 0.29 | <0.05 | <0.05 | <0.05 | <0.05 | <0.05 | <0.05 |
| Wood | | | | | | | |
| Painted | 0.27 | <0.05 | <0.05 | <0.05 | <0.05 | <0.05 | <0.05 |
| Steel | | | | | | | |
| Painted | 0.32 | <0.05 | <0.05 | <0.05 | <0.05 | <0.05 | <0.05 |
| Concrete | | | | | | | |

| | | | | 1% | 1% | 1% |
|---|---|---|---|---|---|---|
| | | 1% | 1% | 1:1 | 1:1 | FC/0.5% |
| Object | Control | FC | FS | FC:WAA | FS:WAA | CaO (1:1 soln) |
| CCA | 0.15 | ND | ND | 0.07 | 0.05 | <0.05 |
| Wood | | | | | | |

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of reducing solubility of a heavy metal in wood containing a heavy metal to reduce leaching of the heavy metal from the wood when the wood is exposed to natural or induced leaching conditions, comprising:
applying a stabilizing agent comprising phosphate, silicate, chloride, sulfate, a base, a source of iron ions or a combination thereof onto the wood to produce a treated wood, wherein the stabilizing agent binds to the heavy metal to form a heavy metal complex when exposed to natural or induced leaching conditions.

2. The method of claim 1, wherein the stabilizing agent forms a coating having a thickness of less than about 10 microns on the wood.

3. The method of claim 1, wherein the stabilizing agent comprises phosphate, silicate, a source of iron ions or a combination thereof.

4. A method of reducing solubility of arsenic in wood containing arsenic to reduce leaching of the arsenic from the wood when the wood is exposed to natural or induced leaching conditions, comprising:
applying a stabilizing agent comprising phosphate, silicate, chloride, sulfate, a source of iron ions, a base, or a combination thereof onto the wood to produce a treated wood, wherein the stabilizing agent binds to the arsenic to form an arsenic complex when exposed to natural or induced leaching conditions.

5. The method of claim 4, wherein the wood contains chromated copper arsenate.

6. The method of claim 5, wherein the stabilizing agent comprises phosphate.

7. The method of claim 6, wherein the stabilizing agent forms a coating having a thickness of less than about 10 microns.

8. The method of claim 6, further comprising applying to the wood a composition comprising calcium ions.

9. The method of claim 4, wherein the stabilizing agent comprising phosphate is technical grade phosphoric acid, green phosphoric acid, wet process amber phosphoric acid, phosphoric and sulfuric acid blend coproduct, sodium chloride or calcium chloride amended phosphoric acid or a combination thereof.

10. The method of claim 4, wherein the stabilizing agent comprising silicate is an aqueous solution of sodium silicate.

11. The method of claim 4, wherein the stabilizing agent comprising a source of iron ions contains iron(III) chloride or iron(III) sulfate.

12. The method of claim 4, wherein the stabilizing agent is applied by a wet spray method.

13. The method of claim 12, wherein the wet spray method is a diluted latex wash of the wood.

14. The method of claim 13, wherein the wet spray method comprises applying a dye or stain to the wood.

15. The method of claim 4, wherein the stabilizing agent is applied by a wiping device.

16. The method of claim 15, wherein the wiping device is impregnated with a solution comprising the stabilizing agent.

17. The method of claim 4, wherein the base is lime.

18. A method of reducing solubility of a heavy metal in wood containing a heavy metal to reduce bioavailability of the heavy metal from the wood when the wood is contacted directly by an organism or a substance that directly or indirectly contacts an organism, comprising:
applying a stabilizing agent comprising phosphate, silicate, chloride, sulfate, a base, iron ions or a combination thereof onto the wood to produce a treated wood, wherein the stabilizing agent binds to the heavy metal to form a heavy metal complex.

19. The method of claim 18, wherein the stabilizing agent comprises phosphate, silicate, iron ions or a combination thereof.

20. A wooden object containing a heavy metal, wherein said wooden object is coated with a stabilizing agent comprising phosphate, silicate, chloride, sulfate, a base, iron ions or a combination thereof to produce a treated wooden object, wherein the stabilizing agent binds to the heavy metal to form a heavy metal complex when exposed to natural or induced leaching conditions to reduce leaching of the heavy metal from the wooden object when the wooden object is exposed to natural or induced leaching conditions.

21. The wooden object of claim 20, wherein the heavy metal is arsenic.

22. The wooden object of claim 21, wherein the wooden object contains chromated copper arsenate.

23. The method of claim 20, wherein stabilizing agent comprises phosphate, silicate, iron ions or a combination thereof.

24. A method of reducing solubility of lead on a surface having painted thereon a lead containing paint to reduce leaching of the lead from said surface when said surface is exposed to natural or induced leaching conditions, consisting essentially of:
applying a stabilizing agent comprising phosphate, silicate, chloride, sulfate, a base, iron ions or a combination thereof onto the surface having painted thereon the lead containing paint to produce a treated paint, wherein the stabilizing agent binds to the lead to form a lead complex when exposed to natural or induced leaching conditions,
wherein said treated paint is not removed from said surface and wherein said stabilizing agent forms a coating having a thickness of less than about 10 microns on the surface.

25. The method of claim 24, wherein the stabilizing agent comprises phosphate, silicate, iron ions or a combination thereof.

26. A method of reducing solubility of lead on a surface having painted thereon a lead containing paint to reduce bioavailability of the lead from said surface when said surface is exposed to natural or induced leaching conditions, consisting essentially of:
applying a stabilizing agent comprising phosphate, silicate, chloride, sulfate, a base, iron ions or a combination thereof onto the surface having painted thereon the lead containing paint to produce a treated paint, wherein the stabilizing agent binds to the lead to form a lead complex when exposed to natural or induced leaching conditions,
wherein said treated paint is not removed from said surface and wherein said stabilizing agent forms a coating having a thickness of less than about 10 microns on the surface.

27. The method of claim 26, wherein the stabilizing agent comprises phosphate, silicate, iron ions or a combination thereof.
